(19) United States
(12) Patent Application Publication
(10) Pub. No.: US 2020/0148928 A1
(43) Pub. Date: May 14, 2020

(54) ABRASIVE MATERIAL AND METHOD FOR MANUFACTURING SAME

(71) Applicant: 3M INNOVATIVE PROPERTIES COMPANY, St. Paul, MN (US)

(72) Inventor: Michihiro Yamahara, Kanagawa (JP)

(21) Appl. No.: 16/473,263

(22) PCT Filed: Dec. 20, 2017
(86) PCT No.: PCT/US2017/067505

§ 371 Date: Jun. 25, 2019

(30) Foreign Application Priority Data
Dec. 28, 2016 (JP) 2016-255575

(51) Int. Cl. C09K 3/14; C08K 3/02; C08K 3/34; C08J 9/00; C08J 9/232

(52) U.S. Cl. CPC C09K 3/1436; C08K 3/02; C08K 3/34; C08K 2003/023; C08J 9/232; C08J 2363/00; C08J 2203/22; C08J 9/0066

(57) ABSTRACT

An abrasive material containing a cured product of a thermosetting resin powder, comprising: a porous body having a plurality of bubbles derived from heat-expandable microspheres; and abrasive grains dispersed in the porous body.

### TECHNICAL FIELD

The present invention relates to an abrasive material and a method for manufacturing the material thereof.

### BACKGROUND

Conventionally, abrasive materials formed into disk shapes, plate shapes, and the like, have been used in polishing processes, such as the removal of black skin (oxide film) on steel material. For example, Patent Document 1 discloses a resinoid grinding wheel containing abrasive grains, a binder, and an organic hollow body.

### PRIOR ART DOCUMENTS

### Patent Documents

Patent Document 1: Japanese Unexamined Patent Application No. H11-156725

### SUMMARY OF THE INVENTION

### Problem to be Solved by the Invention

An object of the present invention is to provide an abrasive material that has both high machinability and high durability and can be appropriately used in applications, such as the grinding, polishing, and the like, of steel materials, and a method for manufacturing the abrasive material thereof.

### Means for Solving the Problem

One aspect of the present invention is an abrasive material containing a cured product of a thermosetting resin powder, and including a porous body having a plurality of bubbles derived from heat-expandable microspheres and abrasive grains dispersed in the porous body.

The abrasive material according to one aspect may include a cured foam body of mixed powder containing the thermosetting resin powder, heat-expandable microspheres, and the abrasive grains.

In one aspect, the heat-expandable microspheres may be expandable at a temperature at or below a curing temperature of the thermosetting resin powder.

In one aspect, the thermosetting resin powder may contain an epoxy resin.

In one aspect, an average particle diameter of the thermosetting resin powder may be 5 to 300 μm.

In one aspect, the abrasive grains may contain a first abrasive grain, and a second abrasive grain having smaller granularity than the first abrasive grain.

Another aspect according to the present invention relates to a method for manufacturing the aforementioned abrasive material. This manufacturing method provides: a step for filling a mold with a mixed powder containing a thermosetting resin powder, heat-expandable microspheres, and abrasive grains; and a heating step for heating the mold filled with the mixed powder to melt and cure the thermosetting resin powder.

In one aspect, the heat-expandable microspheres may be expandable at a temperature at or below the heating temperature in the heating step.

### Effect of the Invention

The present invention provides an abrasive material that has both high machinability and high durability and can be appropriately used in applications, such as the grinding, polishing, and the like, of steel materials, and a method for manufacturing the abrasive material thereof.

### DESCRIPTION OF THE PREFERRED EMBODIMENTS

Preferred embodiments of the present invention are described below.

Abrasive Material

The abrasive material according to the present embodiment includes a porous body and abrasive grains dispersed in this porous body. The porous body contains a cured product of a thermosetting resin powder, and has a plurality of bubbles derived from heat-expandable microspheres.

The abrasive material according to the present invention has both high machinability and high durability, and can be appropriately used in applications for steel material grinding and polishing (for example, steel material oxide film removal), and the like.

Thermosetting resin powder is a material where a thermosetting resin composition is formed into a power, and a material that is melted and cured through heating. For example, the thermosetting resin powder may be configured from a composition containing a thermosetting resin and a curing agent, or may be configured from a semi-cured composition containing a thermosetting resin and a curing agent.

For example, the thermosetting resin powder may contain a thermosetting resin, such as an epoxy resin, a phenolic resin, an acrylic resin, a urethane resin, or the like. Of these, the thermosetting resin powder preferably contains an epoxy resin. A more highly durable abrasive material can be obtained because the thermosetting resin powder contains an epoxy resin.

An average particle diameter of the thermosetting resin powder is, for example, preferably at least 5 μm, and more preferably at least 10 μm. Making the average particle diameter of the thermosetting resin powder larger tends to make the thermosetting resin powder easier to produce, and a mixed powder, to be described later, easier to prepare. Furthermore, the average particle diameter of the thermosetting resin powder is, for example, no more than 3000 μm, no more than 2000 μm, no more than 1000 μm, preferably no more than 300 μm, and more preferably no more than 200 μm. Making the average particle diameter of the thermosetting resin powder smaller, tends to enhance dispersibility in a mixed powder, to be described later, and thus tends to make it easier to obtain a uniform abrasive material. Furthermore, as a preferred embodiment, the average particle diameter of the thermosetting resin powder is a value close to the average particle diameter of the abrasive grains, where, in this case, the abrasive particles and the thermosetting resin powder are thus easy to disperse uniformly, making it easy to obtain an abrasive material with a superior appearance. Note that the average particle diameter of the thermosetting resin powder described in the present specification indicates a value measured using a laser diffracting and scattering method (Microtrac particle diameter distribution measuring device (manufactured by Microtracbel (Osaka-shi, Osaka-fu)).

A commercially available powder, for example, PEL-POWDERs PCE-750, PCE-752, XP-1377, XP-1378, XP-1379 (manufactured by Pelnox Limited (Hadano-shi, Kanagawa-ken)), and the like, can be used as the thermosetting resin powder.

Heat-expandable microspheres are microspheres that are expandable through heating.

The heat-expandable microsphere has, for example, a shell configured from a thermoplastic resin, and a volatile component encased inside the shell. With this kind of heat-expandable microsphere, the shell thereof is softened through heating, which heating gasifies the volatile component inside, causing internal pressure to rise and the shell to expand. The volatile component can be, for example, a hydrocarbon, and the like, with a low boiling point.

An average particle diameter of the heat-expandable microsphere is, for example, at least 3 μm, and preferably at least 5 μm. Furthermore, the average particle diameter of the heat-expandable microsphere is, for example, no more than 100 μm, and preferably no more than 45 μm. Note that the average particle diameter of the heat-expandable microsphere described in the present specification indicates a value measured using a laser diffracting and scattering method (Microtrac particle diameter distribution measuring device (manufactured by Microtracbel (Osaka-shi, Osaka-fu)).

Furthermore, a ratio of the average particle diameter of the heat-expandable microsphere to the average particle diameter of the thermosetting resin powder is preferably at least 0.1, and more preferably at least 0.2. Furthermore, the ratio of the average particle diameter of the heat-expandable microsphere to the average particle diameter of the thermosetting resin powder is, for example, no more than 1.2, no more than 1.0, preferably less than 1.0, and more preferably no more than 0.9. When the ratio is within the aforementioned range, the effect of the present invention becomes even more noteworthy.

Commercially available microspheres, for example, Expancels 051-40DU, 053-40DU, 031-40DU, 920-40DU, 920-80DU, 920-120DU, 909-80DU, 930-120DU, 951-120DU, 980-120DU, 551-40DU, 461-40DU, and 461-20DU (manufactured by Japan Fillite (Osaka-shi, Osaka-fu)), and Matsumoto Microspheres F-30, F-36LV, F-48, FN-78, FN-80GS, F-50, F-65, FN-100SS, FN-100S, F-100M, FN-100M, FN-100, FN-105, FN-180SS, FN-180S, FN-180, F-190D, F-230D, F-260D, and F-2800D (manufactured by Matsumoto Yushi-Seiyaku, Co., Ltd. (Yao-shi, Osaka-fu)) can be used as the heat-expandable microsphere.

The porous body contains a plurality of bubbles derived from the heat-expandable microspheres. The bubbles derived from the heat-expandable microspheres are defined as bubbles generated by the shrinking or removal of the heat-expandable microspheres that had expanded during the curing of the thermosetting resin powder. The heat-expandable microspheres or heated residues thereof are encased in the bubbles. Furthermore, the bubbles derived from the heat-expandable microspheres are closed cells, and thus the porous body can be a porous body having closed cells.

The type of the abrasive grains is not particularly limited, and thus can be appropriately varied based on the object to be polished. Examples of abrasive grains include silicon carbide, aluminum oxide, cubic boron nitride, diamond, and the like. In cases where the abrasive material is used in grinding and polishing steel materials, silicon carbide and cubic boron nitride are preferred as the abrasive grains.

An average particle diameter of the abrasive grains is not particularly limited, and thus can be appropriately varied based on the object to be polished. An average particle diameter of the abrasive grains is, for example, preferably at least 1 μm, and more preferably at least 4 μm. Furthermore, it is preferable that the average particle diameter of the abrasive grains is, for example, no more than 2500 μm. Note that the average particle diameter of the abrasive grains in the present specification indicates a value measured in accordance with JIS R 6001 (1998), JIS R 6002 (1998) (ISO 8486-1 (1996) and ISO 8486-2 (1996)).

A contained amount of the abrasive grains is not particularly limited. For example, it is preferable that the contained amount of abrasive grains is at least 20 parts by mass, and more preferably at least 60 parts by mass with respect to a total of 100 parts per mass of the porous body and the abrasive grains. Further, it is preferable that the contained amount of abrasive grains is, for example, no more than 95 parts by mass, and more preferably no more than 80 parts by mass with respect to a total of 100 parts per mass of the porous body and the abrasive grains. Keeping the contained amount of the abrasive grains in the aforementioned range makes it possible to achieve a good balance between the mechanical strength and the polishing capability of the abrasive material.

In a preferred aspect, the abrasive grains may contain a first abrasive grain, and a second abrasive grain having smaller granularity than the first abrasive grain. Containing at least two types of abrasive grains with different granularities tends to improve filling properties of the abrasive grains in the abrasive material, thus further increasing the strength of the abrasive material. Note that granularity being small in the present specification indicates that the granularity type defined in JIS R 6001 (1998) (ISO 8486-1 (1996), and ISO 8486-2 (1996)) is different and the average particle size is smaller.

In the present embodiment, a ratio (P2/P1) of a second abrasive grain average particle diameter P2 to a first abrasive grain average particle diameter P1 is, for example, no more than 0.6, preferably no more than 0.5, and more preferably no more than 0.4. Furthermore, while the lower limit of the aforementioned ratio (P2/P1) is not particularly limited, this ratio is, for example, at least 0.03, and preferably at least 0.06. When the ratio (P2/P1) is as described above, the abrasive material strengthening effect becomes even more noteworthy.

In the present embodiment, the first abrasive grain average particle diameter P1 exerts a significant impact on the polishing characteristics of the abrasive material. Therefore, in the present embodiment, it is preferable that the first abrasive grain average particle diameter P1 be appropriately selected based on a desired polishing characteristic, and that the second abrasive grain average particle diameter P2 then be selected so that the ratio (P2/P1) satisfies the aforementioned preferred range.

In the present embodiment, the first abrasive grain average particle diameter P1 may be at least 500 μm. Using abrasive grains having such a relatively large average particle diameter independently tends to make it harder for the porous body to retain the abrasive grains, and makes it harder to obtain a high strength abrasive material. In contrast to this, combining the first abrasive grain and the second abrasive grain in the present embodiment, improves the filling properties of the abrasive grains, makes it hard for the abrasive grains to fall from the porous body, and enables a stronger abrasive material to be achieved. The first abrasive grain average particle diameter P1 may be, for example, at least 600 μm, or at least 700 μm.

In the present embodiment, a ratio (C2/(C1+C2)) of a second abrasive grain contained amount C2 to a total (C1+C2) of a first abrasive grain contained amount C1 and the second abrasive grain contained amount C2 is, for example, at least 0.1, preferably at least 0.15, and more preferably at least 0.2. Furthermore, the aforementioned ratio (C2/(C1+C2)) is, for example, no more than 0.8, preferably no more than 0.65, more preferably no more than 0.5, and even more preferably no more than 0.4.

A shape of the porous body is not particularly limited, and thus may be a disk shape, a plate shape, a wheel shape, a rectangular shape, a cube shape, or the like.

The abrasive material according to the present embodiment may include a cured foam body of mixed powder containing the thermosetting resin powder, the heat-expandable microspheres, and the abrasive grains. This type of cured foam body is configured from a cured product of the thermosetting resin powder and abrasive grains, and has a plurality of bubbles derived from the heat-expandable microspheres.

The cured foam body is preferably molded into a prescribed shape. The shape of the cured foam body may be a disk shape, a plate shape, a wheel shape, a rectangular shape, a cube shape, or the like.

For example, a cured foam body having a targeted shape can be obtained in the present embodiment by processing a cured foam body that is larger than the targeted shape. Furthermore, a cured foam body having the targeted shape can be obtained in the present embodiment by filling a mold with a mixed power and then curing the powder.

For example, a contained amount of the thermosetting resin powder in the mixed powder is, in terms of the entire amount of the mixed powder, preferably at least 5 wt %, and more preferably at least 20 wt %. Furthermore, for example, the contained amount of the thermosetting resin powder in the mixed powder is, in terms of the entire amount of the mixed powder, preferably no more than 80 wt %, and more preferably no more than 40 wt %.

For example, a contained amount of the heat-expandable microspheres in the mixed powder is, in terms of the entire amount of the mixed powder, preferably at least 0.01 wt %, more preferably at least 0.05 wt %, and even more preferably at least 0.1 wt %. Furthermore, for example, the contained amount of the heat-expandable microspheres in the mixed powder is, in terms of the entire amount of the mixed powder, preferably no more than 10 wt %, and more preferably no more than 5 wt %.

For example, a contained amount of the abrasive grains in the mixed powder is, in terms of the entire amount of the mixed powder, preferably at least 20 wt %, and more preferably at least 60 wt %. Furthermore, for example, the contained amount of the abrasive grains in the mixed powder is, in terms of the entire amount of the mixed powder, preferably no more than 95 wt %, and more preferably no more than 80 wt %.

Heating the mixed powder generates melting and curing of the thermosetting resin powder and expansion of the heat-expandable microspheres, and thus forms the cured foam body. Note that it is best to generate the expansion of the heat-expandable microspheres before the thermosetting resin powder is cured. Furthermore, the expansion of the heat-expandable microspheres may be generated before or after the melting of the thermosetting resin powder. That is, the heat-expandable microspheres may be expandable at a temperature at or below a curing temperature of the thermosetting resin powder.

A heating temperature of the mixed powder may be a temperature that is able to cure the thermosetting resin powder. For example, the heating temperature may be, for example, at least 70° C., but no more than 290° C.

Applications for the abrasive material according to the present embodiment are not particularly limited, and thus the material can be appropriately used in applications for steel material grinding and polishing (for example, steel material oxide film removal), and the like.

(Method for Manufacturing the Abrasive Material)

The method for manufacturing the abrasive material according to the present invention is provided with: a step for filling a mold with a mixed powder containing a thermosetting resin powder, heat-expandable microspheres, and abrasive grains; and a heating step for heating the mold filled with the mixed powder to melt and cure the thermosetting resin powder.

According to the present embodiment, it is easy to manufacture an abrasive material with superior machinability and durability, containing a cured product of a thermosetting resin powder, and including a porous body having a plurality of bubbles derived from heat-expandable microspheres and abrasive grains dispersed in the porous body.

In the present embodiment, the thermosetting resin powder is used as a resin raw material for configuring the porous body, and the heat-expandable microspheres are used as a foaming agent for forming bubbles in the porous body. For example when the resin raw material is in a liquid state, there is a risk that the foaming agent in the liquid resin raw material will precipitate or float, causing foaming to become uneven such that the abrasive grains in the liquid raw material resin will also precipitate and float, causing a polishing performance of the abrasive material to also become uneven. By contrast, because the resin raw material, foaming agent, and abrasive grains are all powders in the present embodiment, they can easily be maintained in a uniformly mixed state while curing and foaming are performed.

Furthermore, the heat-expandable microspheres are used as a foaming agent in the present embodiment. Because the volatile component is encased in a shell, the heat-expandable microspheres can form the porous body without the volatile component leaking out, even when expansion begins before the thermosetting resin powder melts. Therefore, according to the manufacturing method according to the present embodiment, an abrasive material having uniform performance can be manufactured with good reproducibility.

In the filling step, a mold is filled with the mixed powder containing the thermosetting resin powder, the heat-expandable microspheres, and the abrasive grains.

The mixed powder can be obtained by mixing the thermosetting resin powder, the heat-expandable microspheres, and the abrasive grains in, for example, a known mixer, and the like. The contained amount of each component in the mixed powder is as was described above.

The shape of the mold is not particularly limited, and thus can be appropriately varied based on the shape of the target abrasive material. The material of the mold is not particularly limited, and thus can be any material able to withstand the heat of the heating process.

The heating step heats the mold filled with the mixed powder to thus melt and cure the thermosetting resin powder. When the thermosetting resin powder melts in the heating step, gaps between powder particles, and gaps between the mold and the powder particles are filled, and bubbles are generated when the heat-expandable microspheres expand. Because curing progresses in this state, the cured foam body is formed corresponding to the mold.

Note that the expansion of the heat-expandable microspheres may occur before the thermosetting resin powder is cured. Furthermore, the expansion of the heat-expandable microspheres may be generated before or after the melting of the thermosetting resin powder. That is, the heat-expandable microspheres may expand between when heating starts and the thermosetting resin powder is cured, and thus may be heat-expandable microspheres that are expandable at a temperature at or below the heating temperature of the heating step.

The heating temperature may be a temperature that is able to cure the thermosetting resin powder. For example, the heating temperature may be, for example, at least 70° C., but no more than 290° C.

The cured foam body obtained in the heating step may be used as-is as the abrasive material. Furthermore, the cured foam body obtained in the heating step may be used as the abrasive material after attachment of another member, such as a backup pad, and the like, finishing of abrasive grains through surface polishing, and the application of processes, such as size adjustment, and the like, through surface polishing.

Although descriptions were given above for the preferred embodiments of the present invention, the present invention is not limited to the aforementioned embodiments.

### EXAMPLES

The present invention will be described more specifically below using examples, but the present invention is not intended to be limited to the examples.

### Example 1

“PEL-POWDER PCE-752” (manufactured by Pelnox Limited (Hadano-shi, Kanagawa-ken), average particle diameter: 57 μm) was prepared as the thermosetting resin powder, “Expancel 930-120DU” (manufactured by Japan Fillite (Osaka-shi, Osaka-fu), average particle diameter: 28 to 38 μm) was prepared as the heat-expandable microspheres, and Silicon Powder F36 (Nanko Ceramics, Co., Ltd. (Itabashi-ku, Tokyo), average particle diameter: 500 μm) was prepared as the abrasive grains. 30 parts by mass of the thermosetting resin powder, 3 parts by mass of the heat-expandable microspheres, and 70 parts by mass of the abrasive grains were mixed in a powder mixer, and thus a mixed powder was obtained.

A mold (ring-shaped with an outer diameter of 100 mm, an inner diameter of 50 mm, and thickness of 10 mm) was filled with the obtained mixed powder and heated for 120 minutes at 150° C., and thus a cured foam body was obtained. A backup pad was attached to the cured foam body, to create Abrasive Material A-1. The machinability and durability of obtained Abrasive Material A-1 was evaluated according to the following method. The results are shown in Table 1.

Performance Evaluation

Abrasive Material A-1 was attached to a 100ϕ disk grinder. Next, a steel plate (SS400 steel for general structures, size: 300 mm (length)×150 mm (width)×3 mm (thickness)) was prepared, and then reciprocating polishing was performed on a surface thereof at a load of 3 kg and a speed of 3 m/min. The steel plate and the abrasive material were weighed every minute to derive the amount of the steel plate polished away in one minute (that is, the amount by which the weight of the steel plate was reduced in one minute), and the amount of the abrasive material worn away in one minute (that is, the amount by which the weight of the abrasive material was reduced in one minute). This reciprocating polishing and weighing were conducted until the total polishing time reached 25 minutes, and then, the reduction amount of the steel plate was evaluated as machinability, while the reduction amount of the abrasive material was evaluated as durability.

TABLE 1

| Abrasion time (Minutes) | Machinability (g) | Durability (g) |
|---|---|---|
| 1 | 1.04 | 0.78 |
| 2 | 0.44 | 0.22 |
| 3 | 0.46 | 0.20 |
| 4 | 0.36 | 0.25 |
| 5 | 0.38 | 0.24 |
| 6 | 0.43 | 0.25 |
| 7 | 0.38 | 0.23 |
| 8 | 0.40 | 0.18 |
| 9 | 0.38 | 0.22 |
| 10 | 0.43 | 0.23 |
| 11 | 0.40 | 0.23 |
| 12 | 0.38 | 0.20 |
| 13 | 0.33 | 0.19 |
| 14 | 0.38 | 0.21 |
| 15 | 0.42 | 0.26 |
| 16 | 0.43 | 0.24 |
| 17 | 0.41 | 0.24 |
| 18 | 0.39 | 0.21 |
| 19 | 0.38 | 0 19 |
| 20 | 0.37 | 0.19 |
| 21 | 0.39 | 0.19 |
| 22 | 0.42 | 0.23 |
| 23 | 0.39 | 0.25 |
| 24 | 0.41 | 0.24 |
| 25 | 0.39 | 0.25 |

### Comparative Example 1

Except that the heat-expandable microspheres were not added to the mixed powder, a cured foam body was produced in the same way as in Example 1, and a backup pad was attached thereto to create Abrasive Material a-1. The same performance evaluation that was performed for Example 1 was performed for obtained Abrasive Material a-1 The results are shown in Table 2.

TABLE 2

| Abrasion time (Minutes) | Machinability (g) | Durability (g) |
|---|---|---|
| 1 | 1.57 | 0.47 |
| 2 | 1.26 | 0.38 |
| 3 | 1.13 | 0.33 |
| 4 | 1.04 | 0.26 |
| 5 | 0.94 | 0.18 |
| 6 | 0.81 | 0.18 |
| 7 | 0.74 | 0.17 |
| 8 | 0.72 | 0.14 |
| 9 | 0.70 | 0.14 |
| 10 | 0.55 | 0.08 |
| 11 | 0.55 | 0.09 |
| 12 | 0.40 | 0.06 |
| 13 | 0.45 | 0.09 |
| 14 | 0.46 | 0.04 |
| 15 | 0.36 | 0.05 |
| 16 | 0.43 | 0.06 |
| 17 | 0.32 | 0.04 |
| 18 | 0.31 | 0.07 |
| 19 | 0.35 | 0.05 |
| 20 | 0.33 | 0.04 |
| 21 | 0.35 | 0.06 |
| 22 | 0.29 | 0.05 |
| 23 | 0.27 | 0.04 |
| 24 | 0.32 | 0.06 |
| 25 | 0.30 | 0.05 |

### Example 2

“PEL-POWDER PCE-752” (manufactured by Pelnox Limited (Hadano-shi, Kanagawa-ken), average particle diameter: 57 μm) was prepared as the thermosetting resin powder, “Expancel 930-120DU” (manufactured by Japan Fillite (Osaka-shi, Osaka-fu), average particle diameter: 28 to 38 μm) was prepared as the heat-expandable microspheres, and Silicon Powder F14 (Nanko Ceramics, Co., Ltd. (Itabashi-ku, Tokyo), average particle diameter: 1400 μm) was prepared as the abrasive grains. 37.5 parts by mass of the thermosetting resin powder, 0.15 parts by mass of the heat-expandable microspheres, and 62.5 parts by mass of the abrasive grains were mixed in a powder mixer, and thus a mixed powder was obtained.

A mold (ring-shaped with an outer diameter of 100 mm, an inner diameter of 50 mm, and thickness of 10 mm) was filled with the obtained mixed powder and heated for 120 minutes at 150° C., and thus a cured foam body was obtained. A backup pad was attached to the cured foam body, to create Abrasive Material B-1. Abrasive material strength was evaluated for obtained Abrasive Material B-1 according to the following method. The results are shown in Table 3.

Performance Evaluation

Abrasive Material B-1 was attached to a rotation tester, and the abrasive B-1 was caused to rotate idly. Rotational speed was increased at the rate of 500 rpm per second until a rotational speed of 12000 rpm was reached, subsequently, the rotational speed was increased at the rate of 200 rpm per second, and the rotational speed at which Abrasive Material B-1 broke was evaluated as destructive rotational speed.

### Example 3

Silicon Carbide Powder F36 (manufactured by Nanko Ceramics, Co., Ltd. (Itabashi-ku, Tokyo), average particle size: 500 μm) was also prepared, a cured foam body was prepared in the same way as with Example 2 except that, of the 62.5 parts by mass of the abrasive grains, 43.8 parts by mass were Silicon Carbide Powder F14, and 18.7 parts by mass were Silicon Carbide Powder F36, and then, a backup pad was attached to the body to create Abrasive Material B-2. The same performance evaluation that was performed for Example 2 was performed for obtained Abrasive Material B-2. The results are shown in Table 3.

### Example 4

31.8 parts by mass of the thermosetting resin powder, 0.016 parts by mass of the heat-expandable microspheres, and 68.2 parts by mass of the abrasive grains were mixed in a powder mixer, and thus a mixed powder was obtained. Note that, of the 68.2 parts by mass of the abrasive grains, 47.7 parts by mass were Silicon Carbide Powder #14, and 20.5 parts by mass were Silicon Carbide Powder #36.

A mold (ring-shaped with an outer diameter of 100 mm, an inner diameter of 50 mm, and thickness of 10 mm) was filled with the obtained mixed powder and heated for 120 minutes at 150° C., and thus a cured foam body was obtained. A backup pad was attached to the cured foam body, to create Abrasive Material B-3. The same performance evaluation that was performed for Example 2 was performed for obtained Abrasive Material B-3. The results are shown in Table 3.

TABLE 3

| | Destructive Rotational Speed (rpm) |
|---|---|
| Example 2 | 22,150 |
| Example 3 | 24,500 |
| Example 4 | 25,000 |

1. An abrasive material containing a cured product of a thermosetting resin powder, comprising:
a porous body having a plurality of bubbles derived from heat-expandable microspheres; and abrasive grains dispersed in the porous body.

2. The abrasive material according to claim 1, further comprising a cured foam of mixed powder containing the thermosetting resin powder, the heat-expandable microspheres, and the abrasive grains.

3. The abrasive material according to claim 1, wherein the heat-expandable microspheres are expandable at a temperature at or below a curing temperature of the thermosetting resin powder.

4. The abrasive material according to claim 1, wherein the thermosetting resin powder contains an epoxy resin.

5. The abrasive material according to claim 1, wherein an average particle diameter of the thermosetting resin powder is 5 to 300 μm.

6. The abrasive material according to claim 1, wherein the abrasive grains contain a first abrasive grain, and a second abrasive grain having smaller granularity than the first abrasive grain.

7. A method for manufacturing the abrasive material according to claim 1, the method comprising:
a step for filling a mold with a mixed powder containing a thermosetting resin powder, heat-expandable microspheres, and abrasive grains; and
a heating step for heating the mold filled with the mixed powder to melt and cure the thermosetting resin powder.

8. The method according to claim 7, wherein the heat-expandable microspheres are expandable at a temperature at or below the heating temperature in the heating step.
